(19) United States
(12) Patent Application Publication
(10) Pub. No.: US 2023/0185839 A1
(43) Pub. Date: Jun. 15, 2023

(54) Computer Vision Systems and Methods for Segmenting and Classifying Building Components, Contents, Materials, and Attributes

(71) Applicant: Insurance Services Office, Inc., Jersey City, NJ (US)

(72) Inventors: Matthew David Frei, Lehi, UT (US); Ravi Shankar, Fremont, CA (US); Sam Warren, Salt Lake City, UT (US); Caroline Natasha McKee, Salt Lake City, UT (US); Jared Dearth, Lehi, UT (US)

(73) Assignee: Insurance Services Office, Inc., Jersey City, NJ (US)

(21) Appl. No.: 18/082,140

(22) Filed: Dec. 15, 2022

Related U.S. Application Data
(60) Provisional application No. 63/289,726, filed on Dec. 15, 2021.

(51) Int. Cl. G06F 16/45; G06F 16/43; G06N 3/0464; G06N 3/09

(52) U.S. Cl. CPC G06F 16/45; G06F 16/43; G06N 3/0464; G06N 3/09

(57) ABSTRACT

Computer vision systems and methods for segmenting and classifying building components, contents, materials or attributes are provided. The system obtains media content indicative of an asset. The system identifies and segments items of the asset based on one or more segmentation models. The system determines, based on one or more classification models, a value associated with material or other attribute classification for each of the segmented items. The value indicates how likely the segmented item belongs to a particular material or attribute type. The system determines a material or attribute type for each of the segmented items based on a comparison of the confidence value of the material or the attribute to pre-calculated threshold values. The threshold values define a cut-off indicative of a segmented item most likely to be a particular type of material or attribute.

### RELATED APPLICATIONS

The present application claims the benefit of priority of U.S. Provisional Application Ser. No. 63/289,726 filed on Dec. 15, 2021, the entire disclosure of which is expressly incorporated herein by reference.

### TECHNICAL FIELD

The present disclosure relates generally to the field of computer vision. More specifically, the present disclosure relates to computer vision systems and methods for segmenting and classifying building components, contents, materials or attributes.

### RELATED ART

In the insurance industry, various insurance-related actions such as insurance policy adjustments, insurance quote calculations, underwriting, inspections, claiming process and/or property appraisal are often performed. For example, a human operator (e.g., a property inspector) often must physically go to a property site to inspect the property for assessments related to the above actions, and large amounts of paperwork must be generated and processed to evaluate a market value of the property, an insurance quote, a price for an insurance coverage, a remodel cost, an investment value, and/or any related values and costs associated with the above actions based on the inspection. Further, to the extent that there are software tools that can assist with performing some the foregoing tasks, such software tools are severely lacking in their technical capabilities. Still further, such systems require other actions such as flagging changes in rooms over time and populating estimate fields in such software systems (e.g., pre-filling and/or post-checking estimate fields).

The foregoing operations involving multiple human operators are cumbersome and are prone to human error. In some situations, the human operator may not be able to capture accurately and thoroughly all items (e.g., furniture, appliances, doors, windows, ceilings, fences, floors, walls, electronics, structure faces, roof structure, trees, pools, decks, etc.), and recognize materials or attributes of the items, which may result in inaccurate assessment and human bias errors. Thus, what would be desirable are computer vision systems and methods for segmenting and classifying building components and contents, and their associated materials or attributes, which address the foregoing, and other, needs.

### SUMMARY

The present disclosure relates to computer vision systems and methods for segmenting and classifying building components, contents, materials or attributes. The system obtains media content (e.g., a digital image, a video, a video frame, etc.) indicative of an asset (e.g., a real estate property). The system identifies and segments items (e.g., walls, doors, floors, items, materials, contents of structures, etc.) of the asset based on one or more segmentation models (e.g., neural network-based segmentation models). Optionally, the system selects each of the segmented items (e.g., automatically using a mask or based on user input, etc.) and determines, based on one or more classification models (e.g., machine/deep-learning-based classifiers, transformers, etc.), a value associated with material or other attribute classification for each of the segmented items. The value indicates how likely the segmented item belongs to a particular material or attribute type (e.g., wood, laminate, etc.). The system determines a material or attribute type for each of the segmented items based on a comparison of the confidence value of the material or the attribute to pre-calculated threshold values. The threshold values define a cut-off indicative of a segmented item most likely to be a particular type of material or attribute. Each material or attribute can have its own pre-calculated threshold value.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating an embodiment of the system of the present disclosure;

FIG. 2 is a flowchart illustrating overall processing steps carried out by the system of the present disclosure;

FIG. 3 is a diagram illustrating item segmentation and material/attribute processes carried out by the system;

FIG. 4 is a diagram illustrating material or attribute detection carried out by the system;

FIG. 5 is a diagram illustrating example item segmentation and material or attribute detection performed by the system;

FIG. 6 is a diagram illustrating training steps carried out by the system of the present disclosure;

FIG. 7 is a diagram illustrating an example of training dataset generation; and

FIG. 8 is a diagram illustrating hardware and software components capable of being utilized to implement the system of the present disclosure.

### DETAILED DESCRIPTION

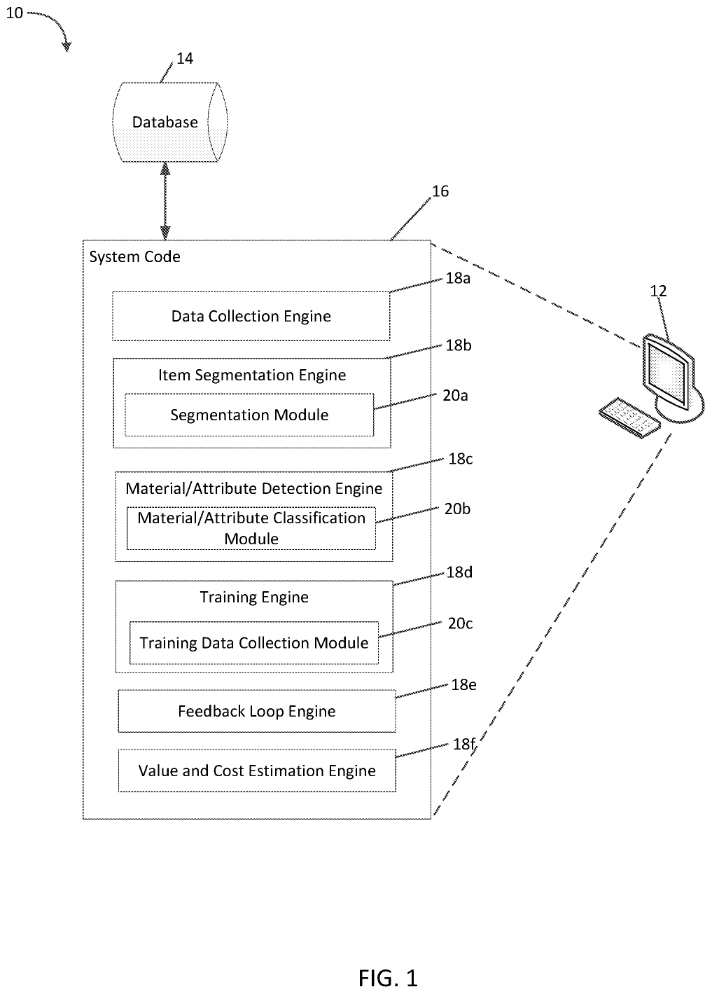

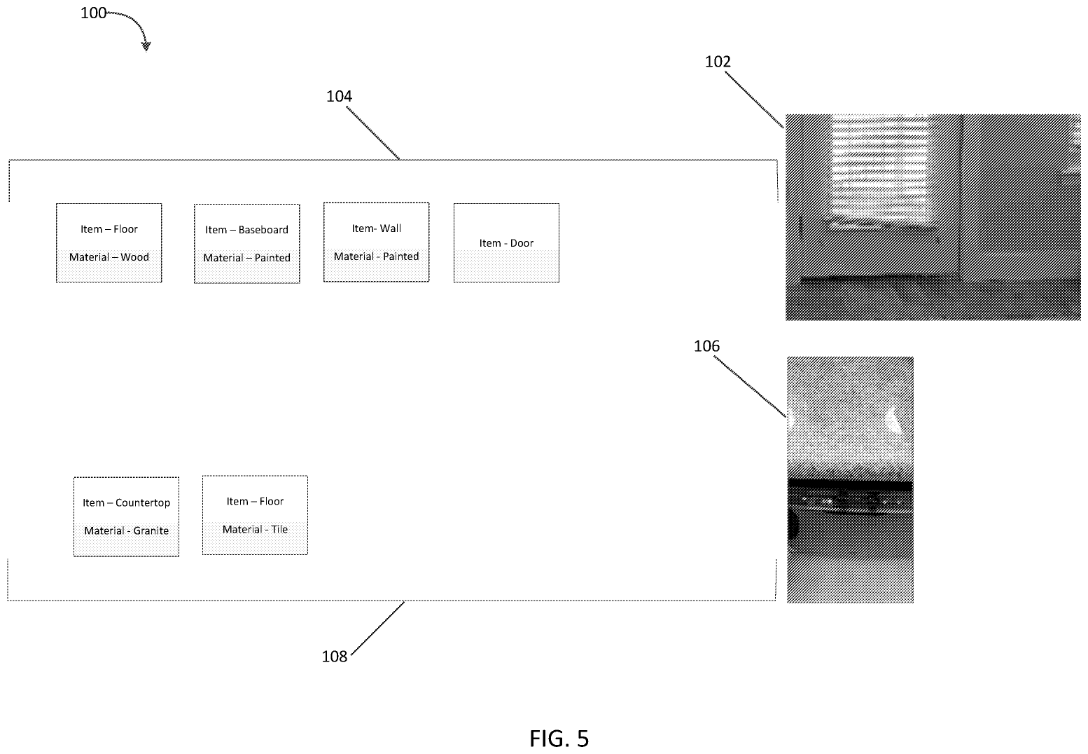

The present disclosure relates to computer vision systems and methods for segmenting and classifying building components, contents, materials and attributes, as described in detail below in connection with FIGS. 1-8.

Turning to the drawings, FIG. 1 is a diagram illustrating an embodiment of the system 10 of the present disclosure. The system 10 can be embodied as a central processing unit 12 (processor) in communication with a database 14. The processor 12 can include, but is not limited to, a computer system, a server, a personal computer, a cloud computing device, a smart phone, or any other suitable device programmed to carry out the processes disclosed herein. The system 10 can retrieve data from the database 14 associated with an asset.

An asset can be a resource insured and/or owned by a person or a company. Examples of an asset can include real estate property (e.g., residential properties such as a home, a house, a condo, an apartment, and commercial properties such as a company site, a commercial building, a retail store, etc.), a vehicle, or any other suitable properties. An asset can include one or more items, such as interior items, and/or exterior items. Additionally, assets can include content items (e.g., personal property such as a refrigerator, television, etc.) present in a building/structure. Examples of the items are shown in Table 1 and Table 2.

TABLE 1
Interior Items

| | | | | | Cabinetry/ | | | |
|---|---|---|---|---|---|---|---|---|
| General | Molding/ | | | | Shelving/ | | Attached | |
| Layout | Trim | Lighting | HVAC | Plumbing | Countertops | Appliances | Accessories | Electric |
| Floor; | Baseboard; | Ceiling | Furnace- | Plumbing | Cabinetry- | Refrigerator; | Door Knob; | Outlet and |
| Interior | Door | Fan and | Forced | Angle | Lower | Dishwasher; | Flooring | Cover; |
| Wall | Molding; | Light; | Air; | Stop | Cabinetry- | Dyer; | Transition | Light |
| (finish); | Window | Chandelier; | Furnace- | Valve; | Upper | Washing | Strip; | Switch |
| Ceiling; | Molding; | Interior | Boiler; | Toilet; | Cabinetry- | Machine; | Towel Bar; | and |
| Door/Arch | Crown | Light | Furnace- | Sink; | Full Height; | Range/Stove/ | Shutters; | Cover; |
| Opening; | Molding; | Fixture | Baseboard | Sink | Cabinetry- | Oven; | Cabinet Knob | Smoke |
| Window | Window | (Attached); | Heater; | Faucet; | Full Height; | Microwave; | or Pull | Detector; |
| (interior | Stool and | Recessed | Radiator; | Showerhead; | Cabinetry- | Range Hood; | Door Stop; | Circuit |
| view); | Apron | Light | A/C | Tub/Shower | Island; | Standalone | Attached | Breaker |
| Door | (Window | Fixture; | Condense- | Faucet; | Built-in | Freezer; | Mirror; | Box, etc. |
| (indoor); | Sill); | Bathroom | Window | Bathtub; | Shelving; | etc. | Toilet Paper | |
| Stairs; | etc. | Fan; | Unit | Laundry | Medicine | | Holder | |
| Stair | | Wall | (Indoor | Tub; | Cabinet; | | (Attached); | |
| Skirt/Apron; | | Lighting; | View); | Plumbing | Vanity; | | Shower | |
| Stair | | etc. | A/C | Pipes; | Fireplace | | Curtain Rod; | |
| Handrail; | | | Condense- | etc. | Mantel; | | Window | |
| Garage | | | Swamp | | Countertop; | | Drapery Rod; | |
| Door- | | | Cooler | | etc. | | Closet | |
| Single | | | (Indoor | | | | Organizer; | |
| (interior | | | View); | | | | Towel Ring; | |
| view); | | | Water | | | | Closet Rod; | |
| Garage | | | Heater- | | | | Window | |
| Door- | | | Tanked; | | | | Screen; | |
| Double | | | Water | | | | Blinds; | |
| (interior | | | Heater- | | | | etc. | |
| view); | | | Tankless; | | | | | |
| Bifold | | | Water | | | | | |
| Door Set; | | | Softener; | | | | | |
| Backsplash | | | Thermostat; | | | | | |
| (Kitchen); | | | Fireplace; | | | | | |
| Shower | | | Bathroom | | | | | |
| Door; | | | Ventilation | | | | | |
| Shower | | | Fan; | | | | | |
| (tiled wall | | | Heat/AC | | | | | |
| enclosure); | | | Register; | | | | | |
| Exposed | | | Battery | | | | | |
| Carpet Pad; | | | Insulation | | | | | |
| etc. | | | etc. | | | | | |

TABLE 2
Exterior Items

| | | Gutters/ | | Molding/ | Attached | |
|---|---|---|---|---|---|---|
| General Layout | Roofing | Pipes/Vents | HVAC | Trim | Accessories | Electric |
| Door (Outdoor); | Roof; | Downspout; | A/C | Exterior | Door | Solar |
| Garage Door-Single; | Roofing | Gutter; | Condenser- | Window/Door | Lockset | Panel; |
| Garage Door- | Ridge | Pipe Jack/Chimney | Central | Trim | and | Solar |
| Double; | Cap/Vent; | Flashing/Jack; | A/C; | | Deadbolt; | Water |
| Fence; | Roof | Roof Vent/Exhaust | A/C | | Exterior | Heater; |
| Window (Exterior | Valley; | Cap; | Condenser- | | Light | Circuit |
| View); | Roof Drip | Gutter | Window | | Fixture; | Break |
| Exterior Wall | Edge; | Guard/Screen; | Unit | | Door Bell; | Box; |
| (Material); | Roof | Attic Vent; | (Exterior | | Awing; | Television |
| Deck Handrail; | Sheathing; | Clothes Dryer Vent | View); | | etc. | Antenna/ |
| Deck; | Roof | Cover; | A/C | | | Satellite |
| Skylight(Exterior | Soffit; | Reflective Tube; | Condenser- | | | Dish; |
| View); | Fascia; | etc. | Swamp | | | etc. |
| Storm Door; | Roof | | Cooler | | | |
| Mobile Home | Reflective | | (Exterior | | | |
| Skirting; | Tube; | | View); | | | |
| Mailbox; | Skylights; | | Chimney- | | | |
| Hot Tub; | etc. | | Direct | | | |
| Swimming Pool; | | | Vent; | | | |
| Storage shed; | | | Chimney- | | | |
| Patio/Pool | | | Masonry; | | | |
| Enclosure; | | | Chimney | | | |
| Garage | | | Case | | | |
| (Attached/Detached); | | | Cover; | | | |
| etc. | | | etc. | | | |

The database 14 can include various types of data including, but not limited to, media content indicative of an asset as described below, one or more outputs from various components of the system 10 (e.g., outputs from a data collection engine 18a, an item segmentation engine 18b, a computer vision segmentation module 20a, a material or attribute detection engine 18c, a material or attribute classification module 20b, a training engine 18d, a training data collection module 20c, a feedback loop engine 18e, a value and cost estimation engine 18f, and/or other components of the system 10), one or more untrained and trained computer vision models, and associated training data, one or more untrained and trained classification models, and associated training data, and one or more data collection models. It is noted that the value and cost estimation engine 18f could comprise and/or communicate with one or more commercially available pricing databases, such as pricing databases provided by XACTWARE SOLUTIONS, INC. The system 10 includes system code 16 (non-transitory, computer-readable instructions) stored on a computer-readable medium and executable by the hardware processor 12 or one or more computer systems. The system code 16 can include various custom-written software modules that carry out the steps/processes discussed herein, and can include, but is not limited to, the data collection engine 18a, the item segmentation engine 18b, the computer vision segmentation module 20a, the material or attribute detection engine 18c, the classification module 20b, the training engine 18d, the training data collection module 20c, the feedback loop engine 18e, and the value and cost estimation engine 18f. The system code 16 can be programmed using any suitable programming languages including, but not limited to, C, C++, C#, Java, Python, or any other suitable language. Additionally, the system code 16 can be distributed across multiple computer systems in communication with each other over a communications network, and/or stored and executed on a cloud computing platform and remotely accessed by a computer system in communication with the cloud platform. The system code 16 can communicate with the database 14, which can be stored on the same computer system as the code 16, or on one or more other computer systems in communication with the code 16.

The media content can include digital images and/or digital image datasets including ground images, aerial images, satellite images, etc. where the digital images and/or digital image datasets could include, but are not limited to, images of the asset. Additionally, and/or alternatively, the media content can include videos of the asset, and/or frames of videos of asset. The media content can also include one or more three-dimensional (3D) representations of the asset (including interior and exterior structure items), such as point clouds, depth maps, light detection and ranging (LiDAR) files, etc., and the system 10 could retrieve such 3D representations from the database 14 and operate with these 3D representations. Additionally, the system 10 could generate 3D representations of the asset, such as point clouds, depth maps, LiDAR files, etc. based on the digital images and/or digital image datasets. As such, by the terms “imagery” and “image” as used herein, it is meant not only 3D imagery and computer-generated imagery (e.g., LiDAR, point clouds, 3D images, etc.), but also two-dimensional (2D) imagery.

Still further, the system 10 can be embodied as a customized hardware component such as a field-programmable gate array (“FPGA”), an application-specific integrated circuit (“ASIC”), embedded system, or other customized hardware components without departing from the spirit or scope of the present disclosure. It should be understood that FIG. 1 is only one potential configuration, and the system 10 of the present disclosure can be implemented using a number of different configurations.

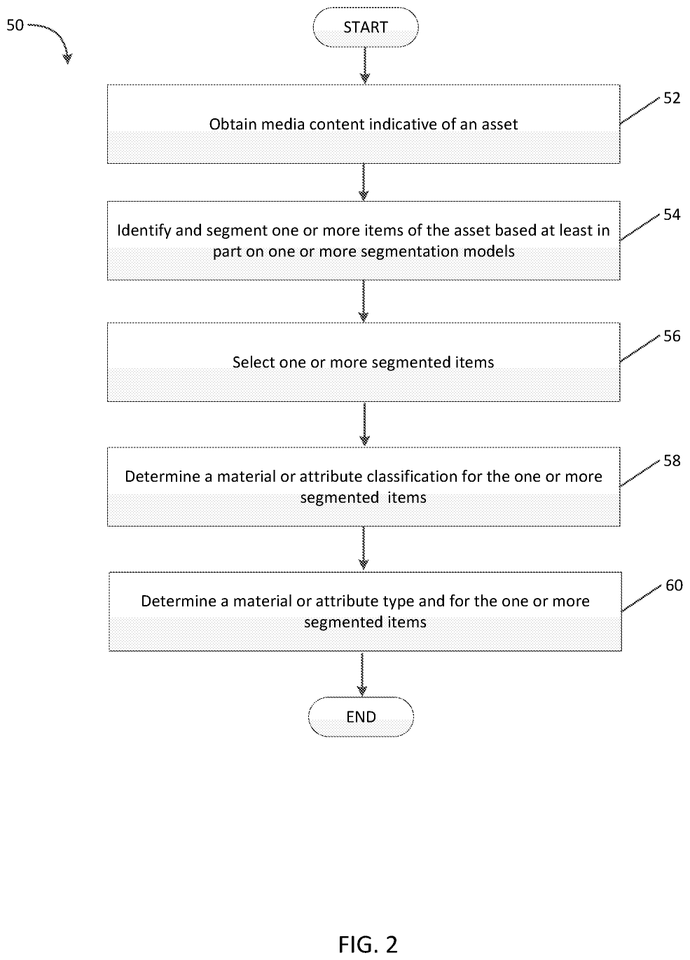

FIG. 2 is a flowchart illustrating overall processing steps 50 carried out by the system 10 of the present disclosure. Beginning in step 52, the system 10 obtains media content indicative of an asset. As mentioned above, the media content can include imagery data and/or video data of an asset, such as an image of the asset, a video of the asset, a 3D representation of the asset, or the like. The system 10 can obtain the media content from the database 14. Additionally, and/or alternatively, the system 10 can instruct an image capture device (e.g., a digital camera, a video camera, a LiDAR device, an unmanned aerial vehicle (UAV) or the like) to capture a digital image, a video, or a 3D representation of the asset. In some embodiments, the system 10 can include the image capture device. Alternatively, the system 10 can communicate with a remote image capture device. It should be understood that the system 10 can perform the aforementioned task of obtaining the media content via the data collection engine 18a. Still further, it is noted that the system 10, in step 52, can receive and process imagery and/or data provided to the system 10 by an external and/or third-party computer system.

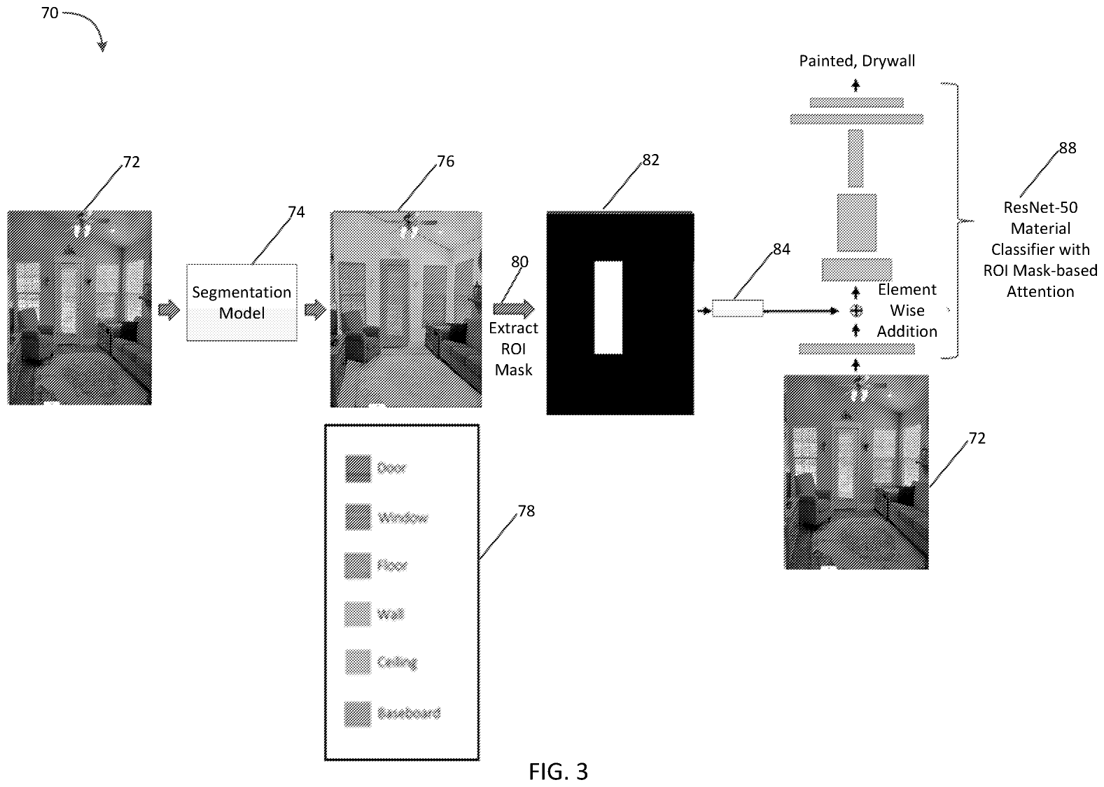

In step 54, the system 10 identifies and segments one or more items of the asset based at least in part on one or more segmentation models. As mentioned above, Table 1 and Table 2 show various examples of an item of the asset (e.g., real estate property). A segmentation model can identify one or more items in the media content and determine which pixels in the media content belong to the detected item. The segmentation model utilizes deep convolutional neural networks (CNNs) to perform an instance segmentation task, such that it detects objects (e.g., structural components and other items noted herein) and predicts a mask (a region of the media content belonging to a particular item) for each object to specify which pixels are to be considered part of the object. For example, as shown in FIG. 3 (which is a diagram illustrating an example 70 of an item segmentation and a material or attribute detection present herein), an image 72 of an interior property is captured and is segmented by a segmentation model 74 into a segmented image 76. The segmented image 76 is an overlay image in which the image 72 is overlaid with a colored mask image, and each color corresponds to a particular item shown in a legend 78. The colored mask image assigns a particular-colored mask/class indicative of a particular detected item to each pixel of the image 72. Pixels from the same object classes have the same color. It should be understood that the system 10 can perform the aforementioned task of segmentation via the item segmentation engine 18b and the segmentation module 20a. It is noted that the mask need not be in color, and could be stored as a binary image if desired.

Returning to FIG. 2, in step 56, the system 10 selects one or more segmented items. This step could be performed completely automatically by the system or based on user input. For example, the system 10 could automatically process each item identified by the system as belonging to one or more of the classes for which the material or attribute classification model has been trained to recognize materials or attributes (e.g., if the segmentation model identifies a region as a floor, the identified region of the floor is automatically passed to a classification model to recognize the floor covering material; another example includes when the segmentation model identifies a region as a door, and the identified region of the door is automatically passed to a classification model to recognize the style of the door). Such identification could be based on a pre-defined list of classes which are subject to material or attribute classification and is built based on specific (e.g., business) requirements. Alternatively, the system 10 can receive a user input indicative of a selection of one or more items to do the material or attribute classification. Additionally, and/or alternatively, the system 10 can automatically select one or more segmented items in a region of interest that can be defined by a user. For example, as shown in FIG. 3, a mask 82 for a region of interest (ROI) corresponding to a wall is extracted in step 80. The mask 82 is generated by the segmentation module 74. In some embodiments, the step 56 can be optional. For example, the system 10 can analyze the segmented items for material detection.

In step 58, the system 10 determines a material or attribute classification for the one or more segmented items. Preferably, only items for which material or attribute recognition makes sense are selected in this step. For example, a floor detection would be subject to material recognition, while a circuit breaker box would not, and a door or window will be subject to attribute classification. Further, a door, a window, or a ceiling can have a style attribute based on the make of the door, window, or ceiling, which can be predicted by the model. A classification model can place or identify a segmented item as belonging to a material or attribute classification, as applicable. Examples of material or attribute classifications of items are provided in Table 3. The placement of the segmented item into the particular material or attribute classification can be based on a value (e.g., a probability value, confidence score, or the like) associated with a material or attribute classification compared to a threshold value. The classification model can be a supervised machine/deep-learning-based classifier, such as CNN based classifier (e.g., ResNet based classifier, AlexNet based classifier, VGG-16 based classifier, GoogLeNet based classifier, or the like). The classification model can include one or more binary classifiers, and/or one or more multi-class classifier. In some examples, the classification model can include a single classifier to identify a material or atttribute type for each segmented item in a region of interest (ROI). In another examples, the classification model can include multiple classifiers each analyzing a particular item for material or attribute detection. The classifier takes as input both the full image, and the ROI, as determined by the segmentation model or via user input. This acts as an ROI-based attention mechanism, thus telling the model which part of the image to classify, while still providing the whole image as contextual input.

TABLE 3
Examples of Material or Attribute Classification for Segmented Items

| | Interior | Exterior | | | | | | |
|---|---|---|---|---|---|---|---|---|
| | Wall/Ceiling | Wall | | | | Downspout/ | Garage | Ceiling |
| Flooring | Finish | Material | Countertops | Cabinets | Roofing | Gutter | Door | Types |
| Tile | Paint; | Brick; | Granite; | Wood; | Asphalt-Break | Metal; | Metal; | Flat; |
| (Marble/ | Unfinished; | Stucco; | Quartz; | etc. | into 3 Tabs vs. | Copper; | Wood/ | Tray; |
| Granite, | Popcorn; | Vinyl | Laminate; | | Architecture; | | Wood | Vaulted; |
| Ceramic, | Paneled; | Siding; | Title; | | Tile-Clay or | | Veneer; | Drop |
| etc.); | Wall Paper; | Aluminum; | Cement; | | Concrete; | | etc. | Ceiling |
| Wood | Tile; | Hardy | Porcelain; | | Metal; | | | (Accoustic |
| (Hardwood | Stone; | (Cement | Marble; | | Rubber (EPDM, | | | Tiles); |
| Plan, | Tin | Board); | Stainless | | TPO); | | | Coffered; |
| Bamboo); | (Ceiling); | Stone; | Steel; | | Wood | | | Sloped; |
| Carpet; | Suspended | Metal- | Concrete; | | Shingles/Shakes; | | | etc. |
| Cement | Ceiling; | Corrugated | Solid | | Slate; | | | |
| (Unfished); | etc. | Galve; | Surface; | | Build-up/Tar and | | | |
| Vinyl Sheet; | | Wood | etc. | | Gravel | | | |
| Stone; | | Clapboard; | | | | | | |
| Slate; | | Wood | | | | | | |
| Cork; | | Shingles/ | | | | | | |
| Terrazzo; | | Shakes; | | | | | | |
| etc. | | | | | | | | |

The classification model can generate a value associated with a material or attribute classification of a segmented item based on a segmentation mask associated with the segmented item. The value can indicate how likely the segmented item belongs to a particular material or attribute type. For example, a door can have a greater value associated with a wood material type than a ceramic material type indicating that the door is more likely to belong to the wood material type than the ceramic material type. The classification model can further narrow down the likelihood using threshold values, as described below.

As noted above, the system 10 determines a material or attribute type for the one or more segmented items based at least in part on a comparison of the value to one or more threshold values. For example, continuing the above example, for a situation having a single threshold value indicative of a segmented item most likely to belong to a material or attribute type, if the classification model determines that the value exceeds (e.g., is equal to or is greater than) the single threshold value, the classification model can determine that the segmented item (e.g. a door) is most likely to belong to the material or attribute type (e.g., a wood material type). If the value is less than the single threshold value, the classification model can determine that the segmented item (e.g. a door) is not most likely to belong to the material or attribute type (e.g., a ceramic material type). Additionally, and/or alternatively, a multi-class classification model can generate multiple values associated with different material types or attributes, and can determine whether the segmented item belongs to one or more different material types or attributes. For a situation having more than one value and corresponding threshold value when using a multi-class model (e.g., a first value indicative of a segmented item is most likely to belong to a first material or attribute type, and a second value indicative of segmented item is most likely to belong to a second material or attribute type, and so forth), if the value exceeds a first threshold value, the classification model can determine that the segmented item is most likely to belongs to the first material or attribute type, and so forth. For each item, the classification model outputs a score for every possible material or attribute. Each score in the prediction is assigned a threshold value independently. It should be understood that classifiers of the segmentation models also perform similar functions to identify items. It should be also understood that the system 10 can perform the aforementioned task of classification via the material or attribute detection engine 18c and/or the material or attribute classification module 20b.

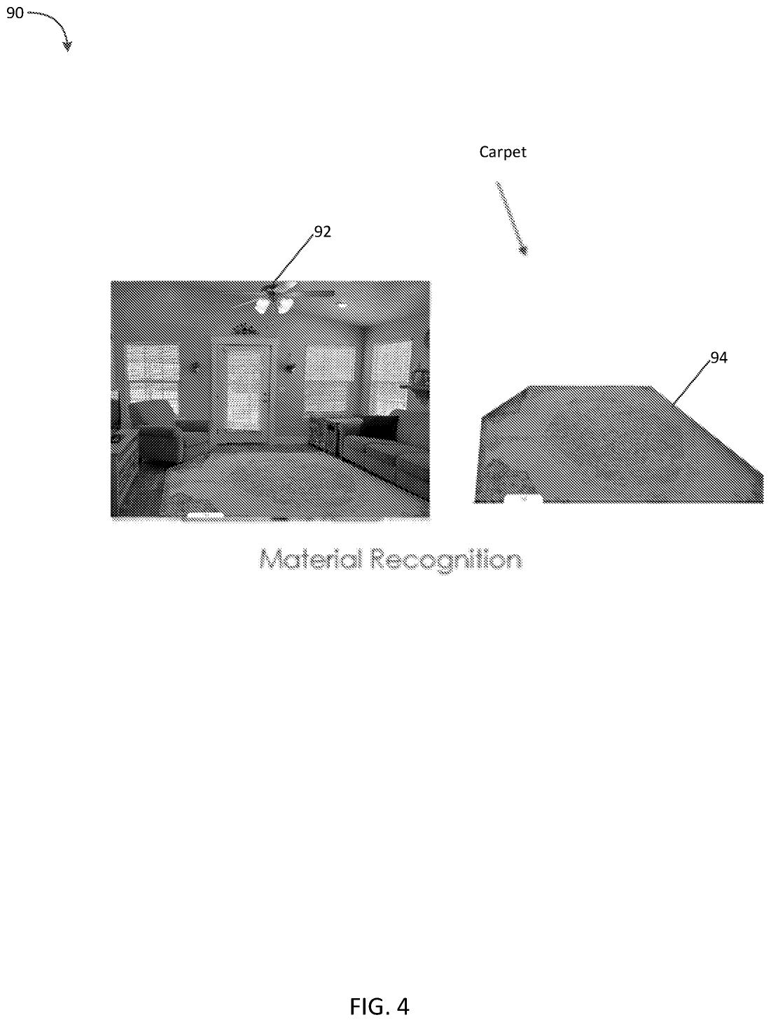

For example, as shown in FIG. 3, the mask 82 corresponding to the item and the image 72 are input into a ResNet-50 material or attribute classifier 88. The mask 82 is inputted into a convolution layer 84 of the ResNet-50 material or attribute classifier 88, and the image 72 inputted into a ResNet-50 block of the ResNet-50 material or attribute classifier 88, and then outputs of the convolution layer 84 and the ResNet-50 block are combined via element-wise vector addition for further processing. The ResNet-50 material or attribute classifier 88 outputs one or more predictions (e.g., painted) of a material or attribute type for the item. As another example, as shown in FIG. 4 (which is a diagram illustrating an example of material or attribute detection present herein), the floor 94 is extracted from an image 92, and can be inputted into a classification model (not shown in FIG. 4). The floor 94 is determined to belong to the carpet material type. After the initial classification, post-processing may be performed to ensure that the material or attribute and item combination makes logical sense. For example, a wall classified as a carpet would be flagged and corrected, using the next most likely material(s) or attribute(s).

In some examples, the system 10 can perform a item segmentation and a material or attribute detection for 3D representations of the asset. For instance, a LiDAR enabled device can capture the 3D representations of the asset. A segmentation model can be used to process the image data. The resulting segmentation masks can then be represented via depth map data, point cloud, mesh, voxel or any other 3D data format. This enables a finer grained segmentation result, material or attribute recognition taking into account a surface texture, automated area measurement, and 3D reconstructions of the scanned space. For example, the segmentation model can perform in two-dimensional (2D) values mapped to 3D values via depth mapping techniques. RGB based segmentations can be overlaid onto RGBD data to create 3D segmentations. The RGBD data for segmented areas can be converted to point cloud, voxel or other 3D format for visualization via 3D scene reconstructions. Combination of the 3D measurement with the segmented areas can automate area/object dimension calculations. As another example, the segmentation can perform directly on 3D data. The segmentation can include one or more additional models to combine the 2D segmentation with depth for finer segmentation results. The additional models can be trained directly on 3D data to obtain a finer grained segmentation, a higher accuracy material or attribute recognition, and an accurate pose estimation and plane/surface detection. In some examples, the system 10 can perform a scene reconstruction via segmented point cloud space representations. As a LiDAR enabled device moves throughout a space, it is capable of creating a reconstruction represented by a point cloud or mesh. Segmentation and classification models can calculate the class and material or attribute associated with each region of the point cloud or mesh. Automated LiDAR based measurement technology can calculate dimensions of each segmented region. Users can input information to clarify areas/objects in the reconstruction. Additional models can be used to predict any gaps within a scanned area to create a continuous surface for a resulting 3D model.

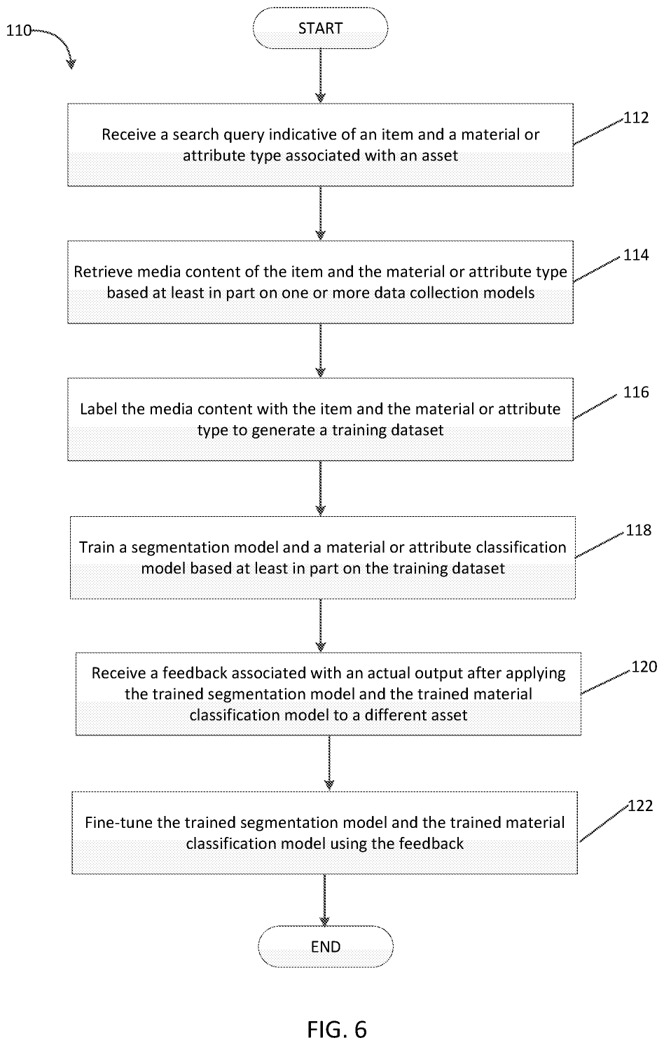

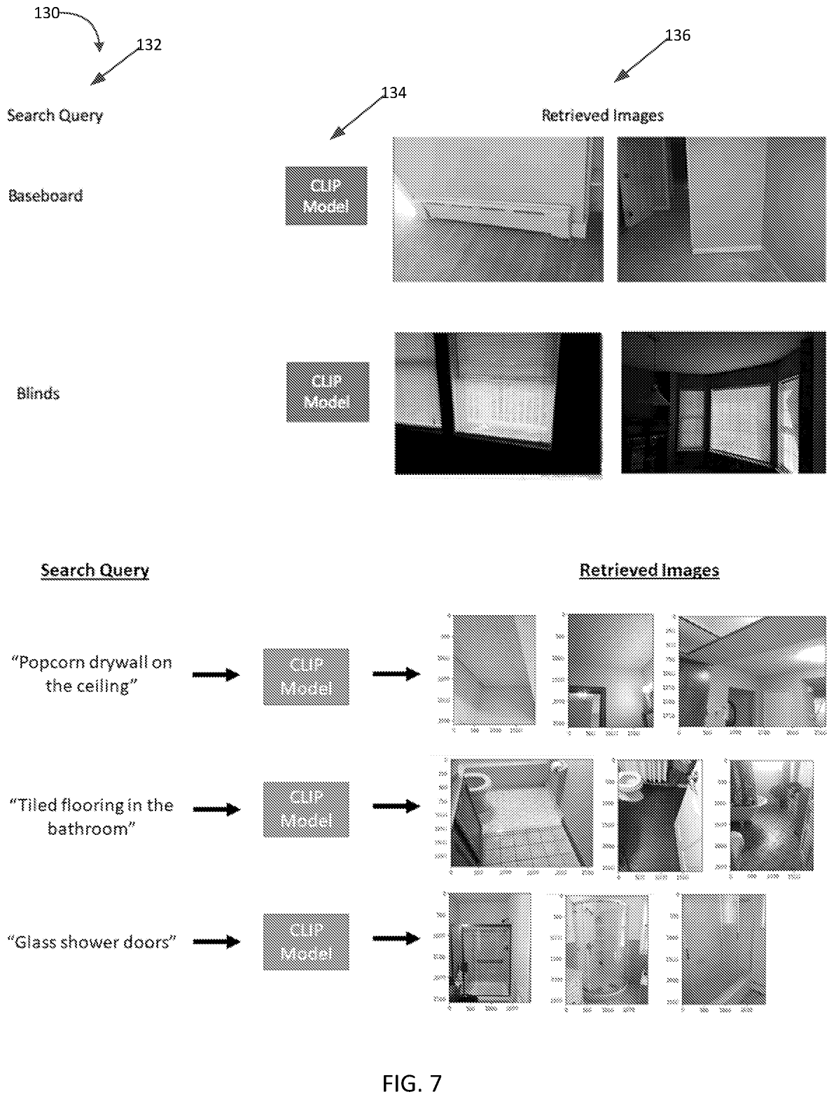

FIG. 6 is a diagram illustrating training steps 110 carried out by the system 10 of the present disclosure. Beginning in step 112, the system 10 receives and/or generates a search query indicative of an item and a material or attribute type associated with an asset. The search query can include one or more words and/or phases to indicate the item and/or the material or attribute type in a form of text input. For example, a user can input a search query (e.g., painted drywall, or the like). As shown in FIG. 7 (which is a diagram illustrating an example 130 of training dataset generation present herein), a search query 132 includes a word indicative of an item (e.g., “baseboard,” “blinds”), and a phrase indicative of an item and a material or attribute type (e.g., “Popcorn drywall on the ceiling,” “Tiled flooring in the bathroom,” “Glass shower doors”).

In step 114, the system 10 retrieves media content of the item and the material or attribute type based at least in part on one or more data collection models. A data collection model can connect a text and/or a verbal command with one or more media content having information of the text and/or the verbal command, such as connecting the search query with one or more images having the item and the material or attribute type. A data collection model can include a machine/deep learning-based model, such as a neural network model. Additionally, and/or alternatively, the data collection model can use a pre-prepared set of keywords and other queries which are then processed by the system, and the returned images are sorted by how well they match the queries to identify the most promising images (such sorting could be performed automatically by the system, or manually by users). The data collection model can retrieve the media content having the item and the material or attribute type (e.g., retrieved images 136 of FIG. 7) from the database 14.

In step 116, the media content is labelled with the item and the material or attribute type to generate a training dataset. For example, the system 10 can generate metadata indicative of the item and the material or attribute type and combine the metadata with the media content to generate a training dataset.

In step 118, the system 10 trains a segmentation model and a material or attribute type classification model based at least in part on the training dataset. For example, the system 10 can adjust one or more setting parameters (e.g., weights, or the like) of the segmentation model and the material or attribute classification model using the training dataset to minimize an error between the generated output and the expected output of the above models. In some examples, during the training process, the system 10 can generate one or more confidence values for an object to be identified as an expected item or for an identified item to be classified to an expected material or attribute type. In step 120, the system 10 receives a feedback associated with an actual output after applying the trained segmentation model and the trained material or attribute classification model to an unseen asset. For example, a user can provide a feedback if there is any discrepancy in the predictions.

In step 122, the system fine-tunes the trained segmentation model and the trained material or attribute classification model using the feedback. For instance, data associated with the feedback can be used to adjust setting parameters of the segmentation model and the material or attribute classification model and can be added to the training dataset to increase an accuracy of predicted results. In some examples, an item (e.g., a countertop) was previously determined to belong to a material type (e.g., a granite material type). A feedback measurement indicates that the item actually belongs to a different material or attribute type (e.g., a laminate material type). The system 10 can adjust (e.g., decrease or increase) weight to weaken the correlation between the item and the material or attribute type. It should be understood that the system 10 can perform the aforementioned task of training steps via the training engine 18d, and the training data collection module 20c, and the system 10 can perform the aforementioned task of feedback via the feedback loop engine 18e.

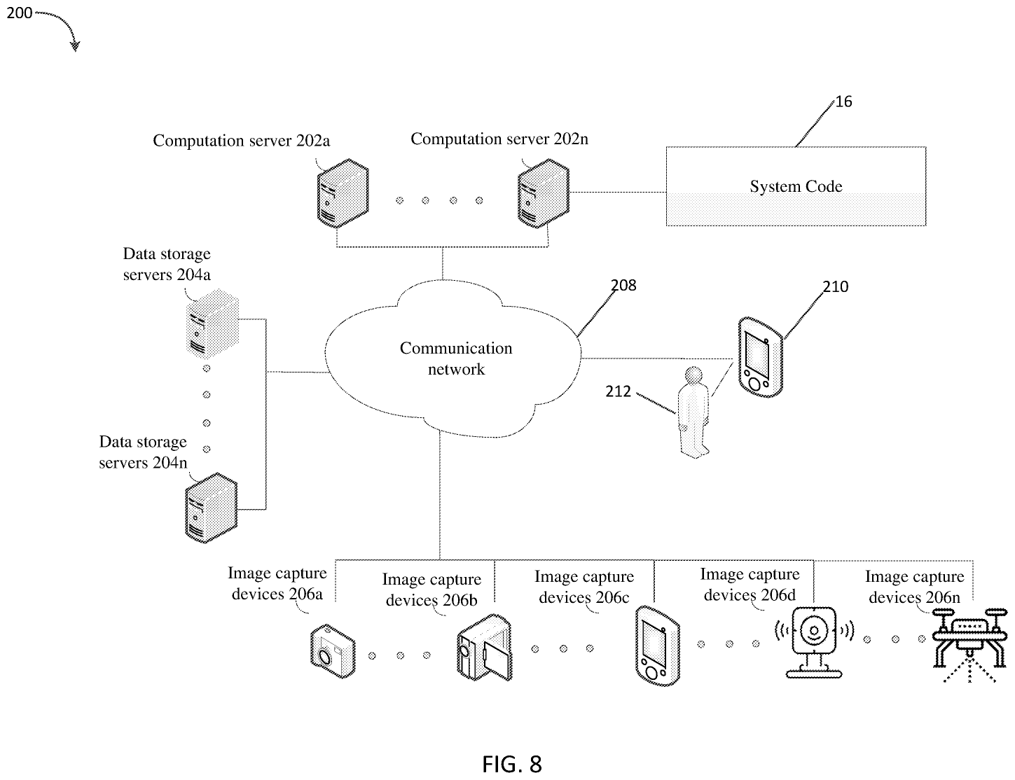

FIG. 8 a diagram illustrating computer hardware and network components on which the system 200 can be implemented. The system 200 can include a plurality of computation servers 202a-202n having at least one processor (e.g., one or more graphics processing units (GPUs), microprocessors, central processing units (CPUs), tensor processing units (TPUs), application-specific integrated circuits (ASICs), etc.) and memory for executing the computer instructions and methods described above (which can be embodied as system code 16). The system 200 can also include a plurality of data storage servers 204a-204n for receiving image data and/or video data. The system 200 can also include a plurality of image capture devices 206a-206n for capturing image data and/or video data. For example, the image capture devices can include, but are not limited to, a digital camera 206a, a digital video camera 206b, a use device having cameras 206c, a LiDAR sensor 206d, and a UAV 206n. A user device 210 can include, but it not limited to, a laptop, a smart telephone, and a tablet to capture an image of an asset, display an identification of an item and a corresponding material or attribute type to a user 212, and/or to provide feedback for fine-tuning the models. The computation servers 202a-202n, the data storage servers 204a-204n, the image capture devices 206a-206n, and the user device 210 can communicate over a communication network 208. Of course, the system 200 need not be implemented on multiple devices, and indeed, the system 200 can be implemented on a single (e.g., a personal computer, server, mobile computer, smart phone, etc.) without departing from the spirit or scope of the present disclosure.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A computer vision system for segmenting and classifying an attribute of an asset, comprising:
a database storing media content indicative of an asset; and
a processor in communication with the database, the processor programmed to perform the steps of:
obtaining the media content from the database;
processing the media content using a segmentation machine learning model to identify and segment one or more items of the asset; and
processing one or more segmented items using a classification machine learning model to identify an attribute of the asset.

2. The computer vision system of laim 1, wherein the asset comprises at least one of real estate property, a vehicle, an interior item, or an exterior item.

3. The computer vision system of claim 2, wherein the attribute comprises at least one of a building component, contents, a material, a condition, a quality grade, or an asset subtype.

4. The computer vision system of claim 1, wherein the media content comprises one or more of a video, a digital image, a digital image dataset, a ground image, an aerial image, a satellite image, or a three-dimensional (3D) representation of the asset.

5. The computer vision system of claim 1, wherein the segmentation machine learning model comprises deep convolutional neural network (CNN).

6. The computer vision system of claim 5, wherein the deep CNN detects objects in the media content and predicts a mask for each detected object that specifies which pixels are to be considered part of the object.

7. The computer vision system of claim 6, wherein the mask is overlaid on the media content.

8. The computer vision system of claim 7, wherein the mask includes at least one color indicative of pixels that correspond to the same object.

9. The computer vision system of claim 1, wherein the classification machine learning model comprises a supervised machine learning or deep learning-based classification model.

10. The computer vision system of claim 9, wherein the classification machine learning model includes one or more binary classifiers.

11. The computer vision system of claim 9, wherein the classification machine learning model includes one or more multi-class classifiers.

12. The computer vision system of claim 1, wherein the processor is programmed to perform the step of:
receiving or generating a search query indicative of an item and a material or attribute type associated with the asset;
retrieving media content corresponding to the item and the material or attribute type;
label the media content with the item and the material or attribute type to generate a training data set; and
training the segmentation model and the classification model based at least in part on the training data set.

13. The computer vision system of claim 12, wherein the processor is programmed to perform the steps of:
applying the trained segmentation model and the trained classification model to a different data set;
receiving feedback after application of the trained segmentation model and the trained classification model; and
fine-tuning the trained segmentation model and the trained material classification model using the feedback.

14. The computer vision system of claim 1, wherein the media content is captured by a mobile device and transmitted to the processor.

15. A computer vision method for segmenting and classifying an attribute of an asset, comprising the steps of:
obtaining at a processor media content stored in a database;
processing the media content using a segmentation machine learning model to identify and segment one or more items of the asset; and
processing one or more segmented items using a classification machine learning model to identify an attribute of the asset.

16. The computer vision method of claim 15, wherein the asset comprises at least one of real estate property, a vehicle, an interior item, or an exterior item.

17. The computer vision method of claim 16, wherein the attribute comprises at least one of a building component, contents, a material, a condition, a quality grade, or an asset subtype.

18. The computer vision method of claim 15, wherein the media content comprises one or more of a video, a digital image, a digital image dataset, a ground image, an aerial image, a satellite image, or a three-dimensional (3D) representation of the asset.

19. The computer vision method of claim 15, wherein the segmentation machine learning model comprises deep convolutional neural network (CNN).

20. The computer vision method of claim 19, wherein the deep CNN detects objects in the media content and predicts a mask for each detected object that specifies which pixels are to be considered part of the object.

21. The computer vision method of claim 20, wherein the mask is overlaid on the media content.

22. The computer vision method of claim 20, wherein the mask includes at least one color indicative of pixels that correspond to the same object.

23. The computer vision method of claim 15, wherein the classification machine learning model comprises a supervised machine learning or deep learning-based classification model.

24. The computer vision method of claim 22, wherein the classification machine learning model includes one or more binary classifiers.

25. The computer vision method of claim 24, wherein the classification machine learning model includes one or more multi-class classifiers.

26. The computer vision method of claim 15, further comprising the steps of:
receiving or generating a search query indicative of an item and a material or attribute type associated with the asset;
retrieving media content corresponding to the item and the material or attribute type;
label the media content with the item and the material or attribute type to generate a training data set; and
training the segmentation model and the classification model based at least in part on the training data set.

27. The computer vision method of claim 26, further comprising the steps of:
applying the trained segmentation model and the trained material classification model to a different data set;
receiving feedback after application of the trained segmentation model and the trained classification model; and
fine-tuning the trained segmentation model and the trained classification model using the feedback.

28. The computer vision method of claim 15, wherein the media content is captured by a mobile device and transmitted to the processor.
